(19) United States
(12) Patent Application Publication
(10) Pub. No.: US 2025/0030655 A1
(43) Pub. Date: Jan. 23, 2025

(54) MAIL CONVERSION PROCESSING DEVICE FOR SAFELY TRANSMITTING MAIL ATTACHED WITH LARGE FILE IN INTERNAL NETWORK OVER SECURITY NETWORK WITH ISOLATED INTERNAL NETWORK TO EXTERNAL NETWORK, AND ITS OPERATION METHOD

(71) Applicant: KIWONTECH CO., LTD., Seoul (KR)

(72) Inventors: Chung Han KIM, Seoul (KR); Seong Hyeon KIM, Seoul (KR); Dong Hyeon LEE, Sejong (KR)

(21) Appl. No.: 18/548,544

(22) PCT Filed: Nov. 25, 2022
(86) PCT No.: PCT/KR2022/018797

§ 371 Date: Aug. 31, 2023

(30) Foreign Application Priority Data
Apr. 28, 2022 (KR) 10-2022-0052826

(51) Int. Cl. H04L 51/08; H04L 9/40; H04L 51/063; H04L 51/066

(52) U.S. Cl. CPC H04L 51/08; H04L 51/063; H04L 51/066; H04L 63/0272

(57) ABSTRACT

According to an embodiment of the present invention, there is provided an operation method of an electronic mail processing device located in an isolated internal network of a security network separated from an external network, the method comprising the steps of: acquiring a transmission mail requested to be transmitted from a sender device located in the internal network; identifying link information of a large file located in the isolated internal network from the transmission mail; acquiring the large file located in the isolated internal network on the basis of the link information; generating a conversion mail in which the large file is inserted to be classified as a general attached file of the transmission mail; and transmitting the conversion mail to a mail restoration processing device located in the external network via a network link mail approval device.

### TECHNICAL FIELD

The present invention relates to a mail conversion processing device and an operation method thereof, and more specifically, to a mail conversion processing device and an operation method thereof, which can safely transmit a mail attached with a large file in an isolated internal network over a security network to an external network.

### BACKGROUND ART

In today's society, dependency on cyberculture is increasing in all areas of social life around the world due to advancement in computers and information and communication technologies, and this trend is further accelerated. Recently, as 5G mobile communication with ultra-high speed, ultra-low delay, and hyper-connectivity is commercialized and new services based thereon are introduced, cyber security systems are becoming more important.

According to construction of cyber security systems, technical fields such as Internet of Things (IoT), cloud systems, big data, artificial intelligence (AI), and the like provide a new service environment in combination with the information and communication technologies. A system that provides such a service may be connected to a PC, a portable terminal device, or the like through an Internet network, a wireless network, or the like to be used in real life.

Particularly, email systems used in the information and communication technologies may provide electronic mail service including a message body to send and receive messages using communication lines between users through computer terminals. At this point, emails may attach electronic files containing contents to be shared, and resource connection links (URL; uniform resource locator) may be written in the message body or inserted in the attached file.

Particularly, these resource connection links are conveniently used for transmission of large files. Generally, a mail service server supports temporary storage of large files, and supports to generate an arbitrary encrypted URL for downloading the temporarily stored large files and allocate the URL to a mail, and a receiver who receives the mail may easily download the large files by accessing the URL written in the mail.

However, recently, as concerns about security of emails and data exchange increase, security systems that separate a data exchange system into an internal network and an external network increase, and it is basically set to block transfer of large files. For example, devices permitted to access the internal network may transmit and receive confidential data such as large files only between internal devices, and transfer of data such as large files or the like to the external network is blocked.

Accordingly, when a user accessing the internal network sends a mail to a terminal located in the external network, only general files that can be included in the mail data can be attached, and transfer of internal network resource information to which large files are linked is blocked, and in addition, although an external network user acquires the URL of the internal network, the user may not download a file since access itself is not allowed due to blocking of the network.

That is, although security of mail server systems is strengthened owing to development of various security standard technologies, researches on spam filtering, and advanced encryption methods, there is no way at all of transferring large files located in a security network with a isolated internal network to the external network.

Although current systems have an effect of protecting the network itself by separating internal networks and external networks and blocking data transfer itself, there is a problem in that a lot of inconveniences occur in practical use.

Accordingly, there is no way of designating a path and transferring a large file located in an internal network to an external network in a conventional mail transfer method, there are occasions in which users utilize a method of sharing large files with external networks using a new service such as a cloud file sharing service in order to avoid the inconvenience.

However, the purpose of the cloud file sharing service is to share and propagate data, and accordingly, there is a fatal security problem in that when confidential large files or the like are exposed even once by mistake to a third party other than target users actually sharing the data, it is unable to prevent the confidential data from being openly propagated.

### DISCLOSURE OF INVENTION

### Technical Problem

Therefore, the present invention has been made in view of the above problems, and it is an object of the present invention to provide a mail conversion processing device and an operation method thereof, which can safely transmit a mail attached with a large file in an isolated internal network over a security network to an external network, so that mails containing large files located in the isolated internal network may be safely transferred to users in the external network through a secured mail system, and accordingly, it is possible to implement a network link mail service that enables safe export of large file data in the isolated internal network to the external network without using a detour process such as a cloud file sharing service.

### Technical Solution

To accomplish the above object, according to one aspect of the present invention, there is provided an operation method of an electronic mail processing device located in an internal network of a security network isolated from an external network, the method comprising the steps of: acquiring a transmission mail requested to be transmitted from a sender device located in the internal network; identifying link information of a large file located in the isolated internal network from the transmission mail; acquiring the large file located in the isolated internal network on the basis of the link information; generating a conversion mail in which the large file is inserted to be classified as a general attached file of the transmission mail; and transmitting the conversion mail to a mail restoration processing device located in the external network via a network link mail approval device.

According to another aspect of the present invention, there is provided an electronic mail processing device located in an internal network of a security network isolated from an external network, the device comprising: an internal network link identification unit for identifying, when a transmission mail requested to be transmitted is acquired from a sender device located in the internal network, link information of a large file located in the isolated internal network from the transmission mail; a target file download processing unit for acquiring the large file located in the isolated internal network on the basis of the link information; a general attached mail conversion processing unit for generating a conversion mail in which the large file is inserted to be classified as a general attached file of the transmission mail; and a conversion mail transmission unit for transmitting the conversion mail to a mail restoration processing device located in the external network via a network link mail approval device.

### Advantageous Effects

According to an embodiment of the present invention, it may be processed to acquire a large file located in an isolated internal network from a transmission mail requested to be transmitted from a sender device located in the internal network, generate a conversion mail in which the large file is inserted to be classified as a general attached file of the transmission mail, and transmit the conversion mail to a mail restoration processing device located in an external network via a network link mail approval device.

Therefore, according to an embodiment of the present invention, a mail conversion process may be performed to safely transmit a mail attached with a large file in an isolated internal network over a security network with a isolated internal network to an external network, and this is processed to transfer the mail attached with the large file located in the isolated internal network to a user in the external network through a secured mail system so that the file can be restored safely.

Therefore, according to an embodiment of the present invention, it is possible to implement a network link mail service that enables safe export of large file data in an isolated internal network to an external network without using a detour process such as a cloud file sharing service.

### BRIEF DESCRIPTION OF THE DRAWINGS

FIG. 1 is a conceptual view schematically showing the entire system according to an embodiment of the present invention.

FIG. 2 is a block diagram showing a mail conversion processing device according to an embodiment of the present invention in more detail.

FIG. 3 is a block diagram showing a mail restoration processing device according to an embodiment of the present invention in more detail.

FIG. 4 is a ladder diagram illustrating the operation of the entire system according to an embodiment of the present invention.

FIG. 5 is a flowchart illustrating the operation of a mail conversion processing device according to an embodiment of the present invention.

FIG. 6 is a flowchart illustrating the operation of a receiver terminal receiving mail of a mail restoration processing device according to an embodiment of the present invention.

### BEST MODE FOR CARRYING OUT THE INVENTION

Hereinafter, only the principles of the present invention will be exemplified. Therefore, although not clearly described or shown in this specification, those skilled in the art will be able to implement the principles of the present invention and invent various devices included in the spirit and scope of the present invention. In addition, it should be understood that all conditional terms and embodiments listed in this specification are, in principle, clearly intended only for the purpose of understanding the concept of present invention, and not limited to the embodiments and states specially listed as such.

In addition, it should be understood that all detailed descriptions listing specific embodiments, as well as the principles, aspects, and embodiments of the present invention, are intended to include structural and functional equivalents of such matters. In addition, it should be understood that such equivalents include equivalents that will be developed in the future, as well as currently known equivalents, i.e., all devices invented to perform the same function regardless of the structure.

Accordingly, for example, the block diagrams in the specification should be understood as expressing the conceptual viewpoints of illustrative circuits that embody the principles of the present invention. Similarly, all flowcharts, state transition diagrams, pseudo code, and the like may be practically embodied on computer-readable media, and it should be understood that regardless of whether or not a computer or processor is explicitly shown, they show various processes performed by the computer or processor.

In addition, explicit use of the terms presented as processors, controls, or concepts similar thereto should not be interpreted by exclusively quoting hardware having an ability of executing software, and should be understood to implicitly include, without limitation, digital signal processor (DSP) hardware, and ROM, RAM and non-volatile memory for storing software. Other known common hardware may also be included.

The above objects, features and advantages will become more apparent through the following detailed description related to the accompanying drawings, and accordingly, those skilled in the art may easily implement the technical spirit of the present invention. In addition, when it is determined in describing the present invention that the detailed description of a known technique related to the present invention may unnecessarily obscure the gist of the present invention, the detailed description thereof will be omitted.

The terms used in this specification are used only to describe specific embodiments, and are not intended to limit the present invention. Singular expressions include plural expressions unless the context clearly dictates otherwise. It should be understood that in this specification, terms such as “comprise” or “have” are intended to specify existence of a feature, a number, a step, an operation, a component, a part, or a combination thereof described in the specification, not to preclude the possibility of existence or addition of one or more other features, numbers, steps, operations, components, parts, or combinations thereof.

Hereinafter, preferred embodiments of the present invention will be described in more detail with reference to the accompanying drawings. In describing the present invention, in order to facilitate the overall understanding, the same reference numerals are used for the same components in the drawings, and duplicate descriptions of the same components are omitted.

A ‘mail (email)’ used in this specification may collectively refer to terms such as electronic mail, web email, electronic mail, electronic mail materials, and the like exchanged between a user and a terminal device using a computer communication network through a client program installed in the terminal device or a website.

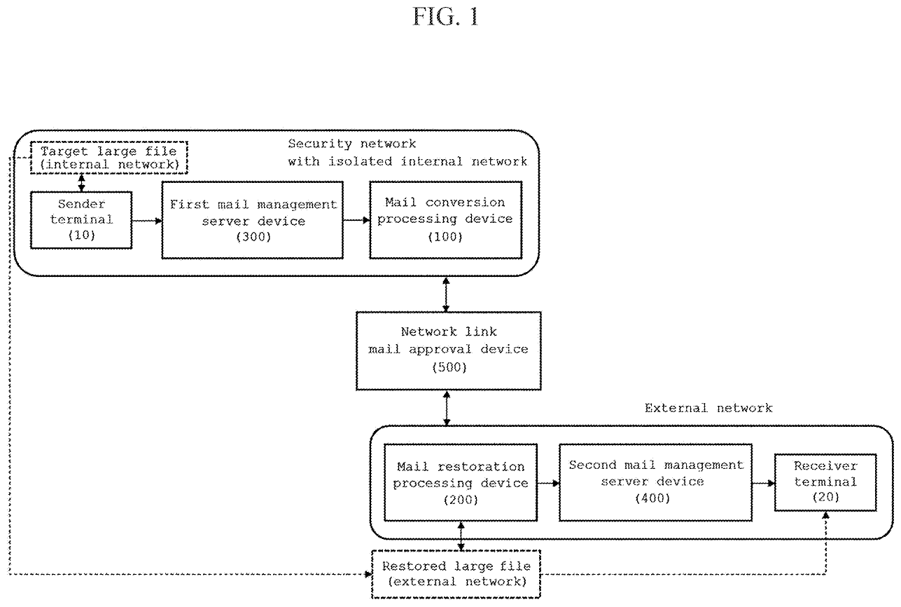

FIG. 1 is a conceptual view schematically showing the entire system according to an embodiment of the present invention.

Referring to FIG. 1, a system according to an embodiment of the present invention includes a sender terminal 10, a first mail management server device 300, a mail conversion processing device 100, a network link mail approval device 500, a mail restoration processing device 200, a second mail management server device 400, and a receiver terminal 20.

More specifically, the sender terminal 10, the first mail management server device 300, and the mail conversion processing device 100 may constitute a security network comprising isolated internal network. The security network with a isolated network is a network capable of transmitting mails to an external network only through the network link mail approval device 500, and secured internal networks and security devices based on various network interface environments may be constructed for this purpose.

To this end, the network link mail approval device 500 may receive a request for approval of electronic mail data to be transmitted to the external network from the first mail management server device 300 constructing a mail server in the internal network, compare the request with preset approval policies, and process export of only approved and security-verified mails to the second mail management server device 400 or the like through the external network.

Here, the preset approval policies may include confirming manager authentication information, confirming approval of a senior member in an organization corresponding to the sender, and inspecting whether electronic mail data is vulnerable to security threats, and approval may be confirmed by comprehensively applying various policies.

On the contrary, when an external mail of an external user is received by the internal network through the second mail management server device 400 of the external network, the network link mail approval device 500 may perform a process of importing only verified mails into the internal network by performing a security inspection on attached files and URLs of the external mail.

Unlike the operation of the internal network system and the network link mail approval device 500 like this, the mail restoration processing device 200, the second mail management server device 400, and the receiver terminal 20 located in the external network are connected to a public network in a wired or wireless manner to transmit and receive data. The public network is a communication network constructed and managed by the country or a telecommunication infrastructure operator, and generally includes a telephone network, a data network, a CATV network, a mobile communication network, and the like, and may provide connection services so that unspecified many people may access other communication networks or the Internet.

Meanwhile, each of the sender terminal 10, the first mail management server device 300, the mail conversion processing device 100, and the network link mail approval device 500 may include a communication module for communicating using a first protocol corresponding to the internal network.

In addition, each of the network link mail approval device 500, the mail restoration processing device 200, the second mail management server device 400, and the receiver terminal 20 may include a communication module for communicating using a second protocol corresponding to the external network.

As described, each of the devices constituting the security network with a isolated internal network and the external network may be connected to each other through a wired/wireless network, and the devices or terminals connected to each network may communicate with each other through a secured network channel.

Here, each of the networks may be implemented as various types of wired/wireless networks, such as a local area network (LAN), a wide area network (WAN), a value-added network (VAN), a personal area network (PAN), a mobile communication network, or a satellite communication network.

In addition, although the sender terminal 10 and the receiver terminal 20 described in this specification may include a personal computer (PC), a laptop computer, a mobile phone, a tablet PC, a Personal Digital Assistant (PDA), a Portable Multimedia Player (PMP), and the like, the present invention is not limited thereto, and may include, for example, various devices capable of accessing the first mail management server device 300 or the second mail management server device 400 through the internal network, a public network, a private network, or the like. In addition, each of the sender terminal 10 and the receiver terminal 20 may be various devices capable of inputting and outputting information through application driving or web browsing.

Meanwhile, each of the first mail management server device 300 and the second mail management server device 400 includes a system that relays and stores electronic mail contents to send a mail written by a user or receive a mail written by a counterpart, and may communicate with each other using a preset mail protocol according to the purpose of receiving and sending mails.

Generally, Post Office Protocol 3 (POP3) and Internet Message Access Protocol (IMAP) may be used as the mail protocol when receiving a mail. In addition, Simple Mail Transfer Protocol (SMTP) or Electronic Mail (EML) protocol may be used as the protocol when sending a mail. In this way, each of the first mail management server device 300 and the second mail management server device 400 may be configured to operate as a server system for processing mail transmission and reception in each isolated network.

In the system configuration like this, the mail conversion processing device 100 according to an embodiment of the present invention may be located in an internal network of a security network isolated from an external network, and may process a function of converting an electronic mail including link information of a large file located in the isolated internal network, receiving approval of the network link mail approval device 500, and transferring the electronic mail to the mail restoration processing device 200 of the external network.

To this end, first, the mail conversion processing device 100 may acquire a transmission mail requested to be transmitted from the sender terminal 10 located in the internal network through the first mail management server device 300, identify link information of a large file located in the isolated internal network from the transmission mail, and acquire the large file located in the isolated internal network on the basis of the link information.

In addition, the mail conversion processing device 100 may generate a conversion mail in which the large file is inserted to be classified as a general attached file of the transmission mail, and the conversion mail may be transmitted to the mail restoration processing device 200 located in the external network through the network link mail approval device 500.

In this case, the network link mail approval device 500 may inspect security risk of the large file inserted to be classified as a general attached file, and approve transmission of the conversion mail according to preset mail transmission policies, and the approved conversion mail may be received by the mail restoration processing device 200 according to an embodiment of the present invention before being transferred to the second mail management server device 400.

The mail restoration processing device 200 may be located in the external network separated from the internal network of the security network, and when the conversion mail converted and transmitted from the internal network is received through the network link mail approval device 500, the mail restoration processing device 200 may perform a restoration and transfer process of configuring a restoration mail including the large file in the isolated internal network restored from the conversion mail, and transferring the configured restoration mail to the receiver terminal 20 via the second mail management server device 400.

More specifically, the mail restoration processing device 200 may acquire the large file in the isolated internal network from the general attached file data included in the conversion mail, separate the large file of the internal network from the conversion mail, and upload the large file on an encrypted arbitrary external network path.

Then, the mail restoration processing device 200 configures the restoration mail of the conversion mail by including the uploaded external network path information in the conversion mail from which the large file is separated, and the configured restoration mail may be transferred to the second mail management server device 400 and transmitted to the receiver terminal.

According to the system configuration like this, a large file of the isolated internal network that could not be exported to the external network is processed to be exported through a secured electronic mail system, and through this process, a mail service that allows a mail receiver of the external network to easily confirm large files of the internal network can be implemented while utilizing a security system of a mail system as it is.

For example, when a user of the sender terminal 10 of the internal network simply inputs a file to be exported through a mail as a large file attachment of a general email, the receiver terminal 20 may acquire the large file restored and uploaded to be the same as the large file attachment of the transmission mail from the external network path information included in the received mail, and therefore, export of a large file can be processed practically.

In addition, since the access right and access information of the external network on the large files may be managed by the mail restoration processing device 200, the vulnerable security environment inevitably used in the existing cloud sharing service or the like can be complemented, and more convenient and safe transmission of internal network files to the external network by mail can be accomplished.

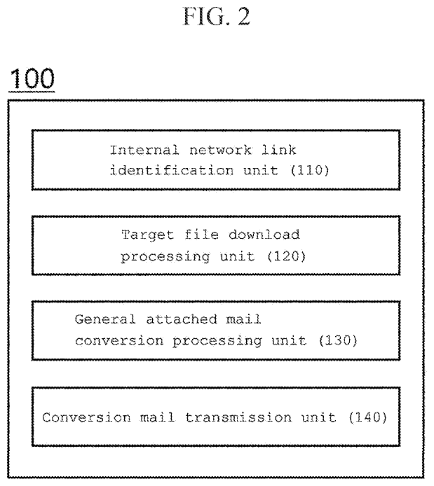

FIG. 2 is a block diagram showing a mail conversion processing device according to an embodiment of the present invention in more detail.

Referring to FIG. 2, the mail conversion processing device 100 according to an embodiment of the present invention includes an internal network link identification unit 110, a target file download processing unit 120, a general attached mail conversion processing unit 130, and a conversion mail transmission unit 140.

First, when the internal network link identification unit 110 acquires a transmission mail requested to be transmitted from the sender device 10 located in the internal network through the first mail management server device 300, the internal network link identification unit 110 identifies link information of a large file located in the isolated internal network from the transmission mail.

Then, the target file download processing unit 120 performs a download process for acquiring the large file located in the isolated internal network on the basis of the link information.

Here, the target file download processing unit 120 may be provided with a separate computer-readable storage medium for temporarily storing the large file.

Then, the general attached mail conversion processing unit 130 generates a conversion mail in which the large file is inserted to be classified as a general attached file of the transmission mail.

Here, the general attached mail conversion processing unit 130 may generate the conversion mail in which link information of the large file is deleted from the transmission mail or processed to be deactivated. Accordingly, the conversion mail may include mail contents in which the link information of the large file is deleted from the transmission mail or processed to be deactivated.

In addition, the general attached mail conversion processing unit 130 may generate the conversion mail with data of an Electronic Mail (EML) format including the same email header and authentication information as the transmission mail and having contents information to which the large file is added.

More specifically, the email header information may include the IP address of the mail sending server, information on the host name of the mail sending server, information on the mail domain of the sender, the mail address of the sender, the IP address of the mail receiving server, information on the host name of the mail receiving server, information on the mail domain of the receiver, the mail address of the receiver, information on the protocol of the mail, information on the time of receiving the mail, information on the time of sending the mail, and the like.

In addition, the email header may include network path information required in the process of sending and receiving mail, information on the protocol used between mail service systems for exchanging mail, and the like.

In addition, the email authentication information may include various authentication information such as domain registration information, authentication token information, and the like for email security standards such as SPF, DKIM, and DMARC.

In addition, the contents information of the conversion mail may include the extension of a general attached file, hash information, attached file name, attached file contents body, and the like according to attachment of the large file as a general attached file. Here, the hash information of the attached file may guarantee integrity of the information by inspecting forgery and alteration of the information. The hash information or hash value may be mapped to arbitrary data having a predetermined length through a hash function using a bit string of a predetermined length.

In addition, generally, the attached file may further include additional contents for transferring additional information or requesting a reply of the information, in addition to the message body of the mail that the sender desires to transfer to the receiver, and in the conversion mail according to an embodiment of the present invention, file information of the large file may be processed to be classified as a general attached file and added to the additional contents. In addition, the message body of the mail may be further included in the contents information of the conversion mail.

Then, the conversion mail transmission unit 140 transfers the conversion mail to the mail restoration processing device 200 located in the external network via the network link mail approval device 500. That is, it may be requested to approve transmission of the conversion mail transferred in this way to the network link mail approval device 500 in replace of the transmission mail of the sender terminal 10.

Then, as described above, the network link mail approval device 500 may inspect security risk of the large file inserted to be classified as a general attached file, and approve transmission of the conversion mail, according to preset mail transmission policies.

Here, the network link mail approval device 500 may use preset approval policies as described above, and for example, the approval may be processed by comprehensively applying various policies, such as confirming manager authentication information, confirming approval of a senior member in an organization corresponding to the sender, and inspecting whether electronic mail data is vulnerable to security threats.

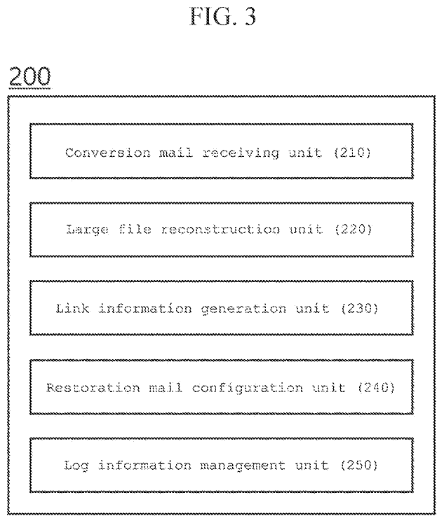

Thereafter, the mail restoration processing device 200 may separate the large file from the conversion mail, upload the large file on an encrypted arbitrary external network path, generate a restoration mail in which the external network path information of the uploaded large file is attached to the conversion mail from which the large file is isolated, and transfer the restoration mail to the receiver terminal 20 through the second mail management server device 400. This will be described in more detail with reference to FIG. 3.

FIG. 3 is a block diagram showing a mail restoration processing device according to an embodiment of the present invention in more detail.

Referring to FIG. 3, the mail restoration processing device 200 according to an embodiment of the present invention includes a conversion mail receiving unit 210, a large file reconfiguration unit 220, a link information generation unit 230, a restoration mail configuration unit 240, and a log information management unit 250.

As described above, the mail restoration processing device 200 according to an embodiment of the present invention may be located in the external network separated from the internal network of the security network.

Then, the conversion mail receiving unit 210 receives the conversion mail, which is converted and transmitted from the internal network, from the network link mail approval device 500.

Here, the large file reconfiguration unit 220 may acquire the large file of the internal network from the general attached file data included in the conversion mail, separate the large file of the internal network from the conversion mail, and upload the large file on an encrypted arbitrary external network path.

Here, the large file reconfiguration unit 220 may upload the large file on a secure shared database managed by the mail restoration processing device 200, and store and manage the encrypted arbitrary external network path information corresponding to the uploaded large file. To this end, the large file reconfiguration unit 220 may include one or more storage media for storing and managing large files on the secure shared database.

Then, the restoration mail configuration unit 240 configures a restoration mail of the conversion mail by including the uploaded external network path information in the conversion mail from which the large file is separated.

Then, the restoration mail configuration unit 240 transfers the restoration mail to the second mail management server device 400 to be transmitted to the receiver terminal 20.

Here, the restoration mail configuration unit 240 may attach the encrypted external network path information of the uploaded large file to the restoration mail in various ways.

More specifically, for example, the restoration mail configuration unit 240 may configure the restoration mail so that the encrypted external network path information of the uploaded large file is attached to the restoration mail as link information.

In addition, for example, the restoration mail configuration unit 240 may configure the restoration mail so that a web page file that may access the encrypted external network path information of the uploaded large file is attached to the restoration mail as a general attached file.

Here, the web page file may include a security page in which the encrypted external network path information is provided only when the receiver authentication information is confirmed.

Accordingly, the receiver terminal 20 may confirm the external network path information included in the received mail through the link information or the web page, and download the large file uploaded on the secure shared database as it accesses the external network path information.

Meanwhile, the log information management unit 250 may manage log information of the receiver terminal in correspondence to the large file uploaded on the encrypted external network path information.

Then, the log information management unit 250 may provide the log information to a security device located in the internal network through the network link mail approval device 500. Here, the security device may be, for example, the first mail management server device 300, the mail conversion processing device 100, or the like, and may be, for example, various other security devices that monitor and protect the internal network.

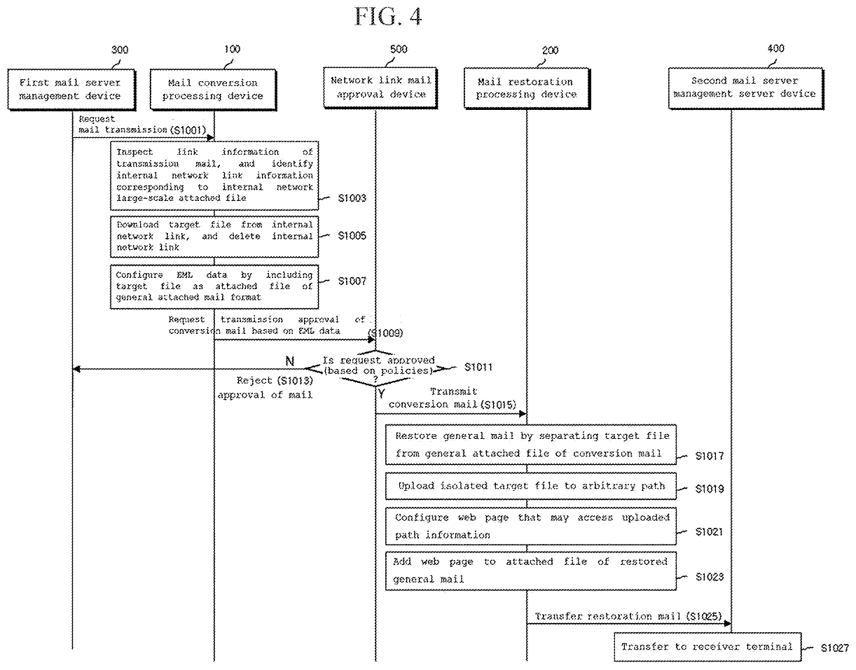

FIG. 4 is a ladder diagram illustrating the operation of the entire system according to an embodiment of the present invention.

Referring to FIG. 4, first, the first mail management server device 300 receives a mail transmission request from the sender terminal 10 and transfers it to the mail conversion processing device 100 (S1001).

Thereafter, the mail conversion processing device 100 identifies internal network link information corresponding to the internal network large-scale attached file from the mail requested to be transmitted (S1003).

In order to identify internal network link information, the mail conversion processing device 100 according to an embodiment of the present invention first extracts link information (URL or URI) included in the mail requested to be transmitted through the internal network link identification unit 110, and perform trace check on the link information.

More specifically, the mail conversion processing device 100 may extract all link information included in the mail requested to be transmitted or designated link information designated as a preset internal network path (e.g., link information starting with a private IP address whose IP address is set to the internal network) through the internal network link identification unit 110, and access the extracted link information to examine whether or not to downloaded and the size of the file.

Accordingly, the internal network link identification unit 110 of the mail conversion processing device 100 identifies information on the size of the file to be downloaded from the link information that is examined to be capable of downloading the file, and when the size information is greater than a predetermined size, it can be identified as link information corresponding to an internal network large-scale attached file.

For example, the predetermined size may be, for example, 2 megabytes, and the internal network link identification unit 110 may extract link information for downloading an internal network file exceeding 2 megabytes among all link information or designated link information, and identify the link information as internal network link information corresponding to the internal network large-scale attached file.

Then, the mail conversion processing device 100 downloads the target file based on the internal network link, and deletes the link to a large file in the isolated internal network from the transmission mail (S1005).

Thereafter, the mail conversion processing device 100 configures EML data by including the target file as an attached file of a general attached mail format in the transmission mail from which the link to a large file is deleted (S1007).

Then, the mail conversion processing device 100 requests approval of transmitting the conversion mail based on the EML data from the network link mail approval device 500 (S1009).

The network link mail approval device 500 may determine whether or not to approve the mail on the basis of preset policies (S1011), and when the approval is rejected, a rejection message is transferred to the sender terminal through the first mail management server device 300 (S1013), and when the approval is confirmed, the conversion mail is transmitted to the mail restoration processing device 200 connected to the second mail management server device 400 of the external network (S1015).

Thereafter, the mail restoration processing device 200 separates the target file from the general attached file of the conversion mail to restore as a general mail (S1017).

Then, the mail restoration processing device 200 uploads the isolated target file on an arbitrary path (S1019), and configures a web page that may access the uploaded path information (S1021).

Thereafter, the mail restoration processing device 200 adds the web page to the attached file of the restored general mail (S1023), and transfers the restored general mail to the receiver terminal 20 through the second mail management server device 400 (S1025, S1027).

Although the upload path information is added as a web page in an embodiment of the present invention, the present invention is not limited thereto, and the upload path information may be attached to the restored general mail in various ways such as link information, URL text, and the like.

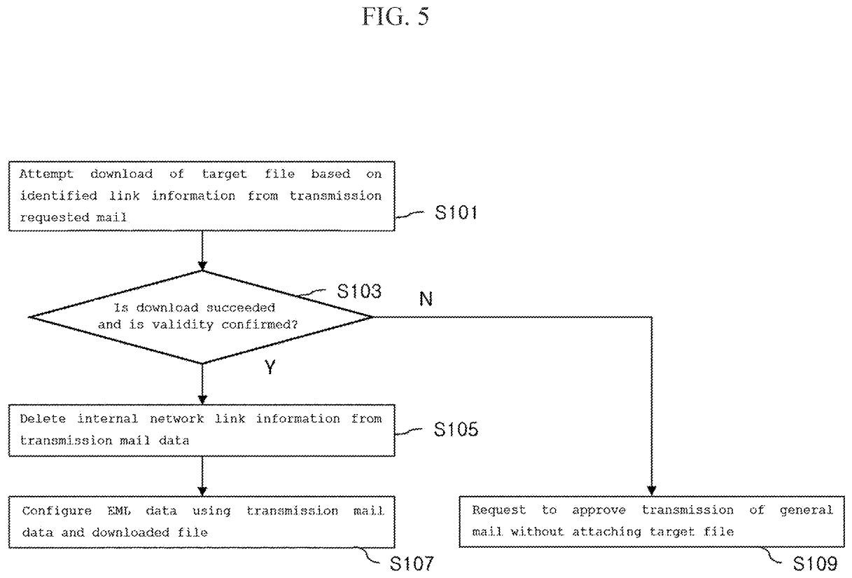

FIG. 5 is a flowchart illustrating the operation of a mail conversion processing device according to an embodiment of the present invention.

Referring to FIG. 5, when the internal network link information is identified from a mail of the sender terminal 10 requested to be transmitted, the mail conversion processing device 100 according to an embodiment of the present invention may attempt download of the target file based on the identified link information (S101).

When download of the target file succeeds and validity such as vulnerability inspection on the data or the like is confirmed (S103), the mail conversion processing unit 100 may delete the internal network link information from the mail requested to be transmitted (S105), and configure EML data using transmission mail data and the downloaded file (S107).

On the other hand, when download of the target file fails or validity such as vulnerability inspection on the data or the like is not confirmed, the mail conversion processing device 100 may request the network link mail approval device 500 to approve transmission of a general mail without attaching the target file (S109).

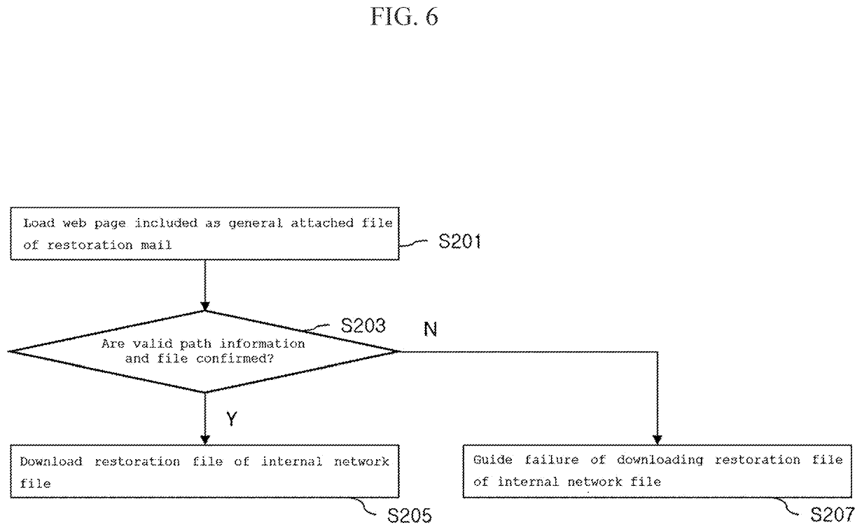

FIG. 6 is a flowchart illustrating the operation of a receiver terminal receiving mail of a mail restoration processing device according to an embodiment of the present invention.

Referring to FIG. 6, the receiver terminal 20 loads, through a web application or the like, a web page such as an HTML file included as a general attached file of the restoration mail received from the mail restoration processing device 200 via the second mail management server device 400 (S201).

Then, the receiver terminal 20 determines whether valid path information and a target file are confirmed through the loaded web page (S203).

When a valid path and a target file are confirmed, the receiver terminal 20 may download the restoration file of the large file in the isolated internal network uploaded by the mail restoration processing device 200 (S205).

When a valid path is not confirmed or download of the target file fails, the receiver terminal 20 may output a guidance of failure to download the restoration file of the internal network file (S207).

The methods according to the present invention described above may be manufactured as a program to be executed on a computer and stored in a computer-readable recording medium, and examples of the computer-readable recording medium include ROM, RAM, CD-ROM, magnetic tapes, floppy disks, optical data storage devices and the like.

The computer-readable recording medium may be distributed in computer systems connected through a network, so that computer-readable codes may be stored and executed in a distributed manner. In addition, functional programs, codes, and code segments for implementing the method may be easily inferred by the programmers in the art to which the present invention belongs.

In addition, although preferred embodiments of the present invention have been illustrated and described above, the present invention is not limited to the specific embodiments described above, and various modified embodiments can be made by those skilled in the art without departing from the gist of the invention claimed in the claims, and in addition, these modified embodiments should not be individually understood from the spirit or perspective of the present invention.

1. An operation method of an electronic mail processing device located in an isolated internal network of a security network separated from an external network, the method comprising the steps of:
acquiring a transmission mail requested to be transmitted from a sender device located in the isolated internal network;
identifying link information of a large file located in the isolated internal network from the transmission mail;
acquiring the large file located in the isolated internal network on the basis of the link information;
generating a conversion mail in which the large file is inserted to be classified as a general attached file of the transmission mail; and
transmitting the conversion mail to a mail restoration processing device located in the external network via a network link mail approval device.

2. The method according to claim 1, wherein the network link mail approval device inspects security risk of the large file inserted to be classified as a general attached file and approves transmission of the conversion mail, according to preset mail transmission policies.

3. The method according to claim 1, wherein the step of generating a conversion mail includes the step of deleting the link information from the transmission mail.

4. The method according to claim 1, wherein the step of generating a conversion mail includes the step of generating the conversion mail with data of an Electronic Mail (EML) format including the same email header and authentication information as the transmission mail and having contents information to which the large file is added.

5. The method according to claim 1, wherein the conversion mail is transmitted to the network link mail approval device in replace of the transmission mail.

6. The method according to claim 1, wherein the large file is separated from the conversion mail and uploaded on an encrypted arbitrary external network path.

7. The method according to claim 6, wherein the mail restoration processing device generates a restoration mail in which external network path information of the uploaded large file is attached to the conversion mail from which the large file is separated, and transfers the restoration mail to the receiver terminal.

8. An electronic mail processing device located in an isolated internal network of a security network separated from an external network, the device comprising:
an internal network link identification unit for identifying, when a transmission mail requested to be transmitted is acquired from a sender device located in the isolated internal network, link information of a large file located in the isolated internal network from the transmission mail;
a target file download processing unit for acquiring the large file located in the isolated internal network on the basis of the link information;
a general attached mail conversion processing unit for generating a conversion mail in which the large file is inserted to be classified as a general attached file of the transmission mail; and
a conversion mail transmission unit for transmitting the conversion mail to a mail restoration processing device located in the external network via a network link mail approval device.

9. The device according to claim 8, wherein the network link mail approval device inspects security risk of the large file inserted to be classified as a general attached file and approves transmission of the conversion mail, according to preset mail transmission policies.

10. The device according to claim 8, wherein the general attached mail conversion processing unit generates the conversion mail in which the link information of the large file is deleted from the transmission mail.

11. The device according to claim 8, wherein the general attached mail conversion processing unit generates the conversion mail with data of an Electronic Mail (EML) format including the same email header and authentication information as the transmission mail and having contents information to which the large file is added.

12. The device according to claim 8, wherein the conversion mail is transmitted to the network link mail approval device in replace of the transmission mail.

13. The device according to claim 8, wherein the large file is separated from the conversion mail and uploaded on an encrypted arbitrary external network path.

14. The device according to claim 13, wherein the mail restoration processing device generates a restoration mail in which external network path information of the uploaded large file is attached to the conversion mail from which the large file is separated, and transfers the restoration mail to the receiver terminal.
